(19) United States
(12) Patent Application Publication
(10) Pub. No.: US 2009/0215398 A1
(43) Pub. Date: Aug. 27, 2009

(54) Methods and Systems for Establishing Communications Between Devices

(76) Inventors: Mitchell D. Adler, Cupertino, CA (US); Jonathan Jay Andrews, Mountain view, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/037,058

(22) Filed: Feb. 25, 2008

(51) Int. Cl. H04B 7/00

(52) U.S. Cl. 455/41.3

(57) ABSTRACT

At least certain embodiments of the disclosures relate to establishing communications between devices with a first connection. A second connection is established between the devices to transfer data between the devices and/or alter configurations of the devices. In one embodiment, a method includes establishing a first connection between a first device and a second device with a first networking standard and associated first network. The method further includes establishing a second connection between the first device and the second device with a second networking standard and associated second network based on the first connection providing information to at least one of the first and second devices regarding the second network. The method further includes transferring data between the first and second devices using the second networking standard. In one embodiment, the first networking standard is a Bluetooth networking standard and the second networking standard is a WiFi networking standard.

### BACKGROUND OF THE INVENTION

Electronic devices, such as computer systems or wireless cellular telephones or other data processing systems, may often be used with other electronic devices. These devices communicate with each other using a variety of wires, cables, radio signals and/or infrared light beams.

A Bluetooth connection is an example wireless connection that automatically creates a connection between devices. Bluetooth is a networking standard that provides agreement at the physical level (e.g., radio frequency standard) and at the protocol level where devices have to agree on when information will be sent and how much information will be sent. Bluetooth networking transmits data via low power radio waves (e.g., one milliwatt) with a frequency of approximately 2.45 gigahertz (GHz) in order to avoid the chance of interference between various electronic devices.

When Bluetooth-capable devices come within range of each other, an electronic conversation occurs to determine whether these devices have data to share or whether one needs to control the other. The user does not have to press a button or give a command because the electronic conversation occurs automatically.

A Bluetooth pairing or partnership is an example of a relationship created between two devices or a device and a data processing system. It is created by the user in order to exchange information in a secure manner. Creating a Bluetooth partnership between two devices involves entering the same personal identification number (PIN) or passkey on both devices; creating such a partnership is a one-time process. Once a partnership is created, the devices can recognize the partnership and exchange information without entering a PIN again.

One prior approach for connecting electronic devices includes establishing a Bluetooth connection between the devices. Then, authentication occurs between the devices. For example, a Bluetooth device may have different types of security modes such as service-level security and device-level security that protect the Bluetooth device from unauthorized data transmission. Bluetooth users can establish trusted devices that exchange data without asking permission. Finally, the Bluetooth devices can exchange information using the Bluetooth connection. However, the Bluetooth connection has a low power signal and a low data throughput resulting in user frustration.

### SUMMARY OF THE DESCRIPTION

At least certain embodiments of the disclosures relate to establishing communications between devices with a first connection. In these embodiments, a second connection is established between the devices to transfer data between the devices and/or alter configurations of the devices.

In at least certain embodiments, a method establishes communications between devices and transfers data between these devices. The method includes establishing a first connection between a first device and a second device with a first networking standard and associated first network. The method further includes establishing a second connection between the first device and the second device with a second networking standard and associated second network based on the first connection providing information to at least one of the first and second devices regarding the second network. The method further includes transferring data between the first and second devices using the second networking standard and associated second network. The method further includes disconnecting the first connection between the first device and the second device with the first networking standard after establishing the second connection between the first device and the second device. The method further includes transferring data between the first and second devices using the second connection and second networking standard. In one embodiment, the first networking standard is a Bluetooth networking standard and the second networking standard is a WiFi networking standard.

In some embodiments, a method establishes a wireless connection between devices and performs device configuration changes based on the wireless connection. The method includes establishing a first connection between the first device and the second device using a first networking standard. The method further includes identifying a location of the second device based on establishing the first connection between the first device and the second device. The method further includes reacting to the location of the second device by changing a device configuration of the second device. In one embodiment, the method further includes changing the device configuration of the second device by establishing a second connection between the first device and the second device with a second networking standard having a scaled power setting based on identifying the location of the second device.

Other systems and methods are also described, and machine readable media, which contain executable instructions to cause a machine to operate as described herein, are also described.

### BRIEF DESCRIPTION OF THE DRAWINGS

The present invention is illustrated by way of example and not limitation in the figures of the accompanying drawings in which like references indicate similar elements.

FIG. 1 shows an example of a system which includes an example of a device and an example of a data processing system which is used with the device.

FIG. 2 is a flow chart of an embodiment of a method of the disclosures described herein.

FIG. 3 is a flow chart of an embodiment of a method of the disclosures described herein.

FIG. 4A is a perspective view of a portable data processing system in accordance with one embodiment of the disclosures described herein.

FIG. 4B is a perspective view of a portable data processing system in accordance with one embodiment of the disclosures described herein.

FIG. 4C is a perspective view of a portable data processing system in a first configuration (e.g. in an opened configuration) in accordance with one embodiment of the disclosures described herein.

FIG. 4D is a perspective view of a portable data processing system in a second configuration (e.g. in a closed configuration) in accordance with one embodiment of the disclosures described herein.

FIG. 5 is a block diagram of a data processing system in which embodiments of the disclosures can be implemented.

FIG. 6 shows, in block diagram form, a data processing system with two devices and a dock or other connector which couples the devices to the data processing system.

### DETAILED DESCRIPTION

Various embodiments and aspects of the disclosures will be described with reference to details discussed below, and the accompanying drawings will illustrate the various embodiments. The following description and drawings are illustrative of the invention and are not to be construed as limiting the invention. Numerous specific details are described to provide a through understanding of various embodiments of the present invention. However, in certain instances, well-known or conventional details are not described in order to provide a concise discussion of embodiments of the present disclosures.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present invention can relate to an apparatus for performing one or more of the operations described herein. This apparatus may be specially constructed for the required purposes, or it may comprise a general purpose computer selectively activated or reconfigured by a computer program stored in the computer. Such a computer program may include instructions for performing the operations described herein and may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

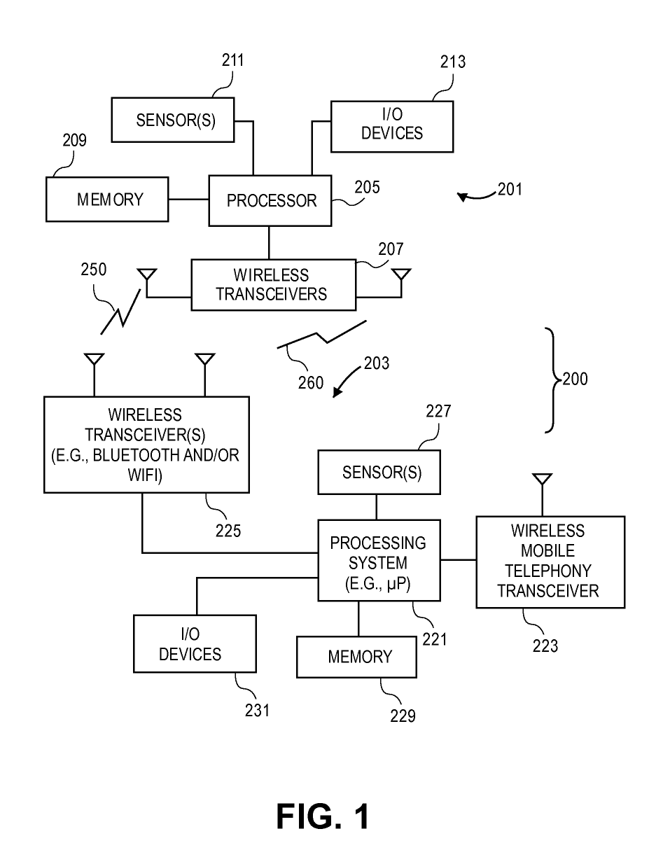

FIG. 1 shows an example of a system 200 which includes a device 201, which may also be referred to as an accessory, and a data processing system 203 capable of exchanging data with the device 201. In the example of FIG. 1, the device 201 communicates with the data processing system 203 through a wireless personal area network (WPAN) interface, such as a Bluetooth interface and/or 802.11 networking (WiFi), and the data processing system 203 may be a wireless mobile cellular telephone or a personal digital assistant (PDA) which also includes a wireless mobile cellular telephone or a general purpose computer system, such as a handheld computer which includes a wireless mobile cellular telephone. It will be appreciated that while a particular type of device and a particular type of data processing system are shown in FIG. 1, other types of devices and data processing systems may be used in alternative embodiments. For example, in alternative embodiments, a device may be a wireless headset or a wired headset or a wired or wireless keyboard or a wired or wireless cursor control device or other wired or wireless input or output devices; in other cases, the device may be considered to be a data processing device which is similar to a PDA or cellular telephone or general purpose computer system. In alternative embodiments, the data processing system may be a general purpose computer system, or special purpose computer system, or an entertainment system, or a PDA or an embedded device within another device, or a media player, etc. The device 201 includes a processor 205 which is coupled to one or more sensors 211, input/output devices 213, memory 209, and wireless transceiver(s) 207. The processor 205 controls the operation of the device 201 by operating the wireless transceiver 207, which may be, for example, a Bluetooth or WiFi transceiver or other types of transceivers used to create a wireless local area network (WLAN) or a WPAN, and by operating the I/O devices 213, in response to signals from the wireless transceiver 207 and/or the sensors and/or processes executing on the processor 205.

In the case where the device 201 is a wireless headset for a telephone, the wireless transceiver 207 establishes a wireless communication link with a telephone which acts as a data processing system and which sends audio data to be played by an I/O device 213 (e.g., audio transducer) and which receives audio data from a microphone (not shown). Thus, the wireless headset acts in the same manner as a wired headset on a telephone.

The sensors 211 may be one or more sensors on the device 201 which are designed to detect or measure user activity or a device context. The sensors 211 may include, for example, a proximity sensor and/or an ambient light sensor and/or an accelerometer and/or other sensors described herein. The sensor(s) 211 provides sensor data (e.g. proximity data) to the processor 205 which may process this data or may transmit, as described below, the sensor data to the data processing system for processing.

The data processing system 203 includes a processing system 221, such as a set of one or more microprocessors, which is coupled to a wireless mobile telephony transceiver 223; the wireless mobile telephony transceiver 223 may be a wireless mobile cellular telephone transceiver which is, to at least some extent, controlled by the processing system 221.

In one embodiment, the data processing system 203 may be a handheld PDA or handheld general purpose computer which includes a wireless cellular telephone. In this case, the RF circuitry needed for the wireless cellular telephone may be provided by the wireless mobile telephony transceiver 223.

The data processing system 203 also includes one or more sensors 227, memory 229, I/O devices 231 and at least one additional wireless transceiver 225, each of which are coupled to the processing system 221. The processing system 221 may include a set of one or more microprocessors which are coupled to the rest of the data processing system 203 through one or more buses.

The one or more sensors 227 may include, for example, a proximity sensor and/or an ambient light sensor and/or an accelerometer and/or other sensors described herein. The sensor data from these one or more sensors 227 is provided to the processing system 221 which may process this data or may transmit this sensor data to the device for processing, as described herein, or both of the device and the processing system 221 may process the sensor data.

The I/O (input/output) devices 231 may include one or more of (a) a keyboard; (b) a touch input panel; (c) a cursor control device (such as, e.g., a joystick or trackpad); (d) speaker; (e) microphone; (f) buttons (such as, e.g., “send” and “end” or other buttons for a cellular telephone); (g) a display device; and (h) other known input/output devices. In one embodiment, a touch input panel may be integrated with a display device to provide both input and output capabilities on the same surface of the display device; this is described further below. These I/O devices allow a user to enter instructions or commands or data to the processing system 221 to cause the system to operate in a manner desired by the user.

The memory 229 may be any combination of DRAM or flash memory or other types of memory including, for example, a magnetic hard drive, and the memory 229 may be coupled to the processing system through one or more memory controllers. The memory 229 may store computer program instructions, including a computer operation system (OS) and user application programs, such as, for example, a web browser application, an email application, a calendar program, an address book application, and other possible applications. The memory 229 may also store user data such as, for example, address and/or contact information, calendar information (e.g. events and tasks), bookmarks/favorites (e.g. “URLs”) and other user data (e.g. word processing documents, spreadsheets, presentations, etc.).

The processing system 221 may retrieve and store computer program instructions and data from the memory 229 in order to allow the user to operate the data processing system 203. Moreover, the memory 229 may store music and/or other media for playback on the data processing system 203, which can allow the user to display and select music and/or other media for playback on a speaker (e.g. an earphone) or a wireless headset of a device, such as device 201.

The wireless transceiver(s) 225 may include one or more wireless transceivers which provide wireless connectivity to other devices, such as the device 201 or a wireless network (e.g. a WiFi network or other wireless local area networks (WLAN) or a wireless personal area network (WPAN), etc.). The wireless transceiver(s) 225 are coupled to the processing system 221 to provide data to the data processing system 203.

In one embodiment, the wireless transceiver(s) 225 include a Bluetooth compliant transceiver to couple wirelessly the data processing system 203 to the device 201 and optionally other devices (e.g. a wireless keyboard) and a WiFi compliant transceiver (e.g. IEEE 802.11 a/g compliant transceiver) to wirelessly couple the system 203 to a wireless network and/or other devices such as the device 201.

The device 201 and the data processing system 203 may be paired together using known techniques, such as the techniques described herein, to create a Bluetooth partnership. The pairing may alternatively involve other techniques which register one device with another device to provide a secure, authenticated communication channel between the device 201 and the data processing system 203.

In one embodiment, the device 201 and the data processing system 203 may be capable of working together to exchange data and/or alter device configuration settings based on a location of the device 201 or data processing system 203. For example, if the device 201 is a home computer and the data processing system 203 is located at home, then the wireless transceiver 225 of the data processing system 203 and the wireless transceiver 207 of the device 201 may establish a Bluetooth connection. The wireless transceiver 225 of the data processing system and the wireless transceiver 207 of the device 201 may then establish a WiFi connection based on the Bluetooth connection providing information to establish the WiFi connection. For example, the Bluetooth connection may inform the data processing system 203 of parameters and password information to establish the WiFi connection with the device 201. In this situation, the device 201 and the data processing system 203 may exchange data, such as instructions which automatically cause a change in configuration of the data processing system 203 given its location at home.

In some embodiments, the data processing system 203 includes a transceiver 225 to detect a wireless signal (not shown) received from a device 201 transmitting the wireless signal. The data processing system 203 includes a processing system 221 coupled to the transceiver 225. The processing system 221 is configured to respond to the detected wireless signal by establishing a first connection 250 between the data processing system 203 and the device 201 using a first networking standard (e.g., Bluetooth). The processing system 221 is further configured to establish a second connection 260 between the data processing system 203 and the device 201 with a second networking standard based on the first connection 250.

In one embodiment, the first connection 250 may provide to the data processing system 203 and/or device 201 parameters and password information for establishing the second connection 260. In another embodiment, the first connection 250 (e.g., Bluetooth beacon) provides the device 201 information regarding a machine (e.g., router, wireless access point, server) associated with the WiFi network in order to locate the WiFi network and establish a WiFi connection with the data processing system 203. In another embodiment, the first connection 250 (e.g., Bluetooth beacon) informs the device 201 of an interesting nearby WiFi network. The device 201 can then locate the WiFi network and establish a WiFi connection with the data processing system 203.

In one embodiment, the processing system 221 is further configured to transfer data between the data processing system 203 and the device 201 using the second networking standard (e.g., WiFi) associated with the second connection 260 in order to transfer data at a high throughput or transmission rate. In other embodiments, a single transceiver 207 establishes the first and second connections with a single transceiver 225.

At least certain embodiments of the disclosures may include a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple Computer, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. patent application numbers 2003/0095096 and 2004/0224638, both of which are incorporated herein by reference.

Embodiments of the disclosures described herein may be part of other types of data processing systems, such as, for example, entertainment systems or personal digital assistants (PDAs), or general purpose computer systems, or special purpose computer systems, or an embedded device within another device, or cellular telephones which do not include media players, or devices which combine aspects or functions of these devices (e.g., a media player, such as an iPod®, combined with a PDA, an entertainment system, and a cellular telephone in one portable device).

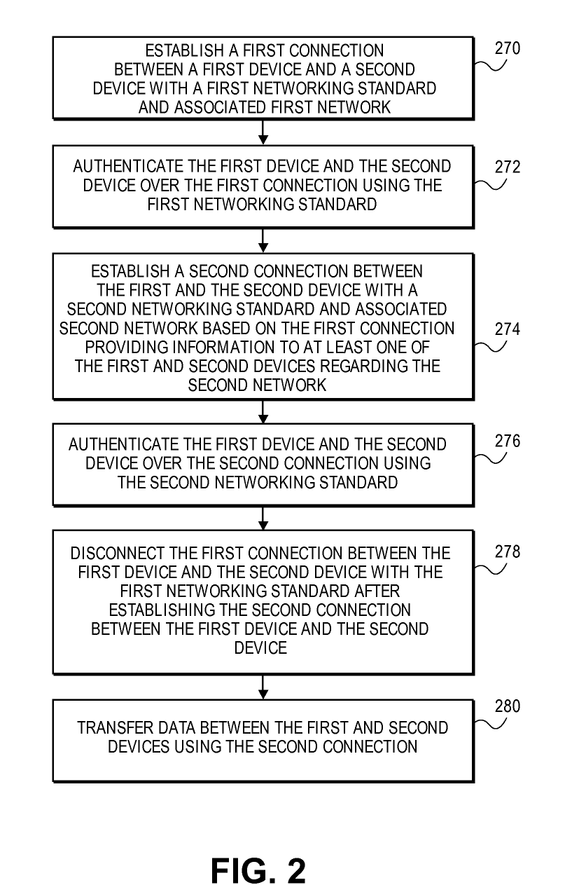

FIG. 2 is a flow chart of an embodiment of a method of the disclosures described herein. In at least certain embodiments, the method establishes communications between devices and transfers data between these devices. The method includes establishing a first connection between a first device and a second device with a first networking standard and associated first network at block 270. The method further includes authenticating the first device and the second device over the first connection using the first networking standard at block 272. The method further includes establishing a second connection between the first device and the second device with a second networking standard and associated second network based on the first connection providing information to at least one of the first and second devices regarding the second network at block 274. The method further includes authenticating the first device and the second device over the second connection using the second networking standard at block 276. The method further includes disconnecting the first connection between the first device and the second device with the first networking standard at block 278 after establishing the second connection between the first device and the second device. The disconnecting of the first connection can occur at any time after the second connection is established. The method further includes transferring data between the first and second devices using the second connection and second networking standard at block 280.

In one embodiment, the first networking standard is a Bluetooth networking standard and the second networking standard is a WiFi networking standard. Using a Bluetooth connection for the first connection enables an automatic discovery of Bluetooth devices within a certain range of each other. The Bluetooth signal is transmitted at a low power thus conserving battery power. After the Bluetooth connection has been established, a WiFi connection can be used for the second connection in order to use a higher power signal to transfer data at a high throughput such as 54 megabits of data per second or higher.

In one embodiment, the first connection is across a wireless local area network (WLAN) such as a Bluetooth network that provides the device(s) with protocols, security parameters and password information for establishing the second connection which is also across a WLAN such as a WiFi network that is further connected to the internet. In another embodiment, the first connection (e.g., Bluetooth beacon) provides the device(s) information regarding a machine (e.g., router, wireless access point, server, other device) associated with the WiFi network in order to locate the WiFi network and establish a WiFi connection with the data processing system 203. In another embodiment, the first connection 250 (e.g., Bluetooth beacon) informs the device 201 of an interesting nearby WiFi network. The device 201 can then locate the WiFi network and establish a WiFi connection with the data processing system 203.

In one embodiment, a Bluetooth connection is automatically established between a home computer and a cellular phone located within a certain proximity to the home computer. The home computer and cellular phone are authenticated as trusted devices. The cellular phone may appear as a wireless device that is hidden from the home computer until a Bluetooth connection is established. Then, a WiFi connection can be established between the home computer and the cellular phone for various purposes. For example, the home computer may have recently downloaded music that needs to be transferred to the cellular phone. The transfer of musical data can occur at a high rate using the WiFi connection. Alternatively, the cellular phone may contain data that needs to be transferred to the home computer via the WiFi or other high speed connection. The home computer and cellular phone can also perform synchronization operations at this time.

In another embodiment, a Bluetooth connection is automatically established between a data processing system located in an automobile and a cellular phone located within a certain proximity to the automobile. The data processing system and cellular phone are authenticated as trusted devices. Next, a WiFi connection can be established between the data processing system and the cellular phone for various purposes. For example, the cellular phone may contain data (e.g., music, maps) that needs to be transferred to the data processing system via the WiFi or other high speed connection. Also, incoming phone calls associated with the cellular phone can be routed through the data processing system in order for a driver of the automobile to receive phone calls in a hands free manner.

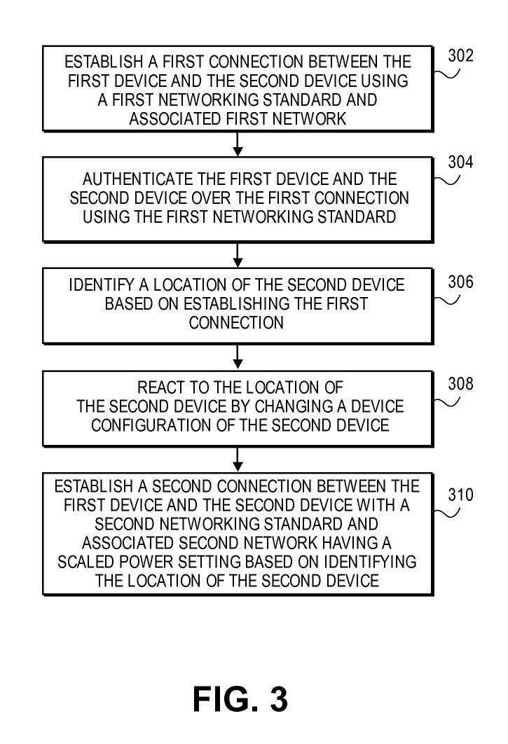

FIG. 3 is a flow chart of an embodiment of a method of the disclosures described herein. In one embodiment, the method establishes a wireless connection between devices and performs device configuration changes based on the wireless connection. The method includes establishing a first connection between the first device and the second device using a first networking standard at block 302. The method further includes authenticating the first device and the second device over the first connection using the first networking standard at block 304. The method further includes identifying a location of the second device based on establishing the first connection between the first device and the second device at block 306. The method further includes reacting to the location of the second device by changing a device configuration of the second device at block 308. In one embodiment, the method further includes changing the device configuration of the second device by establishing a second connection between the first device and the second device with a second networking standard having a scaled power setting based on identifying the location of the second device.

For example, if the second device is located at home, then an appropriate scaled power setting of the second connection is applied to the second device. Devices located closer in distance require a lower power setting associated with the second connection. The second connection may be a WiFi connection or other type of peer to peer connection. The first connection may be a Bluetooth connection that indicates a certain proximity between the first and second devices. This proximity determines the power setting of the WiFi connection.

In one embodiment, reacting to the location of the second device includes automatically transferring data between the first device and the second device using the second connection. For example, the first device may be located in an automobile and the second device may be a cellular telephone. The two devices establish the second connection and then certain data may automatically transfer between the devices.

In some embodiments, changing the device configuration of the second device includes at least one of changing email server settings of the second device, changing a ringer state of the second device, changing a background setting of the second device, prohibiting voice calls to or from the second device, switching from a cellular network for voice calls to a voice over IP network, and changing a chat status.

In other embodiments, device configurations of the first device and/or second device are altered in response to establishing the first connection between the first and second devices and determining the location of these devices. For example, device configurations of either device may be altered if it is determined that the devices are located in a movie theatre, coffee shop, airport, etc.

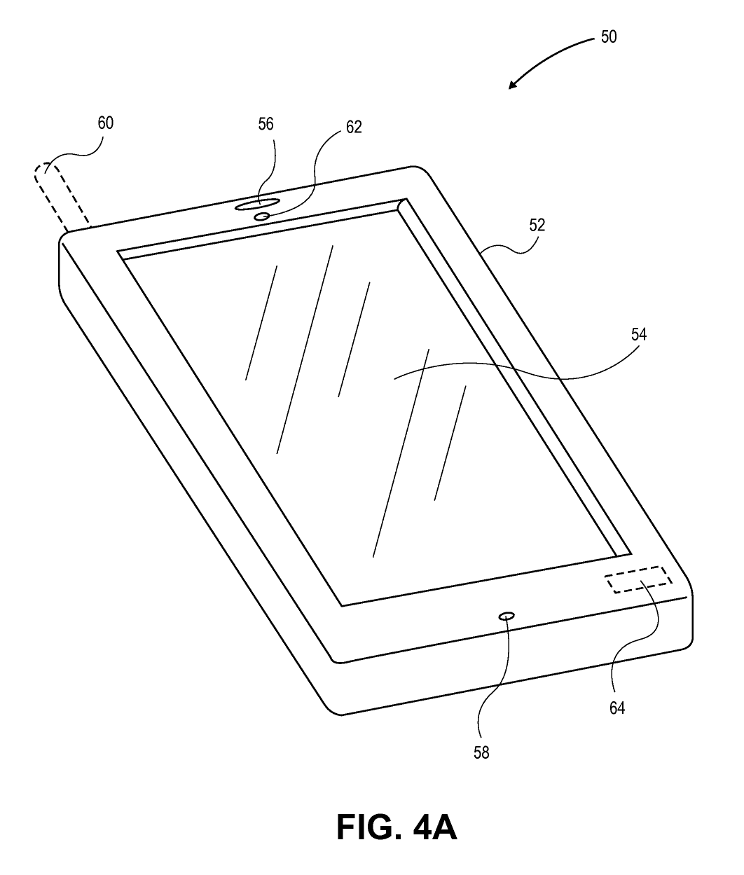

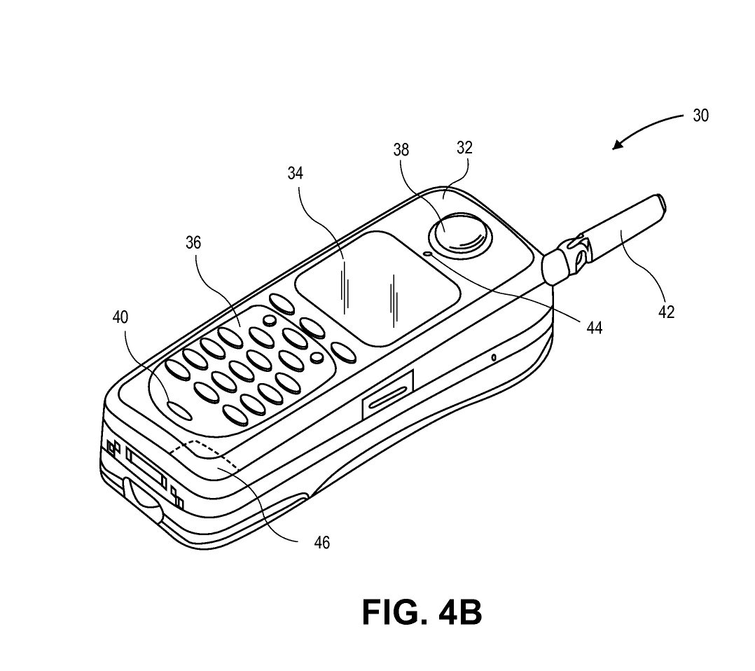

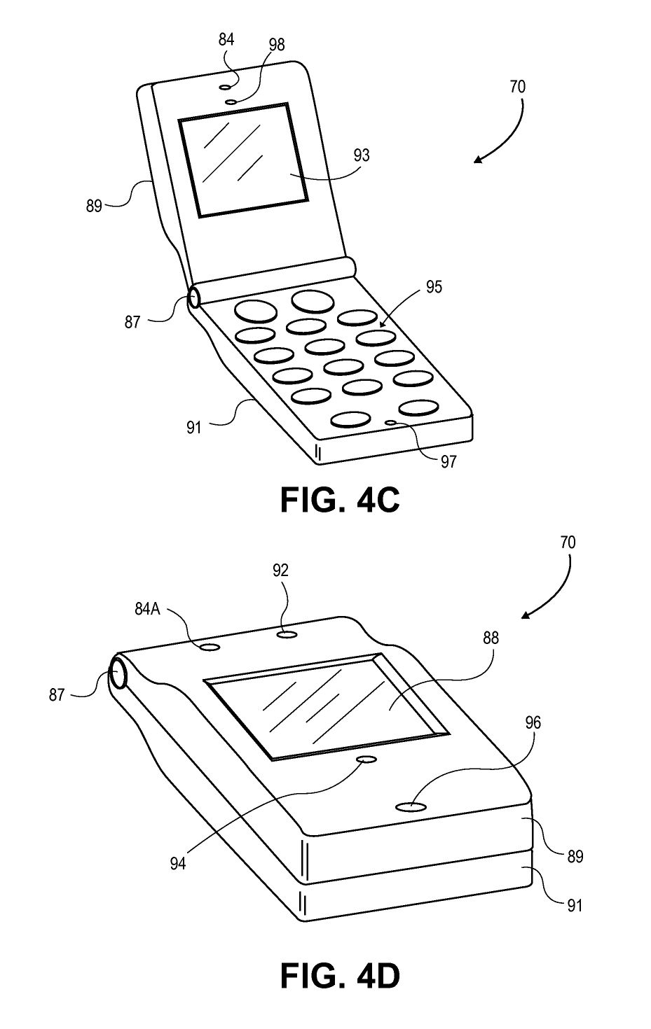

FIG. 4A shows a portable device 50 in accordance with one embodiment of the invention. The portable device 50 may include a housing 52, a display/input device 54, a speaker 56, a microphone 58 and an optional antenna 60 (which may be visible on the exterior of the housing or may be concealed within the housing) with the antenna 60 being coupled to one or more wireless transceivers (e.g., mobile telephony, Bluetooth, WiFi). The portable device 50 also may include a proximity sensor 62 and an accelerometer 64 and optionally other sensors (e.g. an ambient light sensor). The portable device 50 may be a cellular telephone or a device which is an integrated PDA and a cellular telephone or a device which is an integrated media player and a cellular telephone or a device which is both an entertainment system (e.g. for playing games) and a cellular telephone, or the portable device 50 may be other types of devices described herein. In one particular embodiment, the portable device 50 includes a cellular telephone and a media player and a general purpose computer, all contained within the housing 52. The portable device 50 may be implemented as an embodiment of the data processing system 203 shown in FIG. 1 and may operate with a device in a manner which is shown in FIG. 1 and is described in the present disclosures. The portable device 50 may have a form factor which is small enough that it fits within the hand of a normal adult and is light enough that it can be carried in one hand by an adult. It will be appreciated that the term “portable” means the device can be easily held in an adult user's hands (one or both); for example, a laptop computer and an iPod are portable devices.

FIG. 4B illustrates a data processing system according to one embodiment of the invention. This data processing system of FIG. 4B may be implemented as an embodiment of the data processing system 203 shown in FIG. 1. FIG. 4B shows a wireless device in a telephone configuration having a “candy-bar” style. In FIG. 4B, the wireless device 30 may include a housing 32, a display device 34, an input device 36 which may be an alphanumeric keypad, a speaker 38, a microphone 40 and an antenna 42 with the antenna 42 being coupled to one or more wireless transceivers (e.g., mobile telephony, Bluetooth, WiFi). The wireless device 30 also may include a proximity sensor 44 and an accelerometer 46. It will be appreciated that the embodiment of FIG. 4B may use more or fewer sensors and may have a different form factor from the form factor shown in FIG. 4B.

The display device 34 is shown positioned at an upper portion of the housing 32, and the input device 36 is shown positioned at a lower portion of the housing 32. The antenna 42 is shown extending from the housing 32 at an upper portion of the housing 32. The speaker 38 is also shown at an upper portion of the housing 32 above the display device 34. The microphone 40 is shown at a lower portion of the housing 32, below the input device 36. It will be appreciated that the speaker 38 and microphone 40 can be positioned at any location on the housing, but are typically positioned in accordance with a user's ear and mouth, respectively. The proximity sensor 44 is shown at or near the speaker 38 and at least partially within the housing 32. The accelerometer 46 is shown at a lower portion of the housing 32 and within the housing 32. It will be appreciated that the particular locations of the above-described features may vary in alternative embodiments.

The display device 34 may be, for example, a liquid crystal display (LCD) which does not include the ability to accept inputs or a touch input screen which also includes an LCD. The input device 36 may include, for example, buttons, switches, dials, sliders, keys or keypad, navigation pad, touch pad, touch screen, and the like.

FIGS. 4C and 4D illustrate a portable device 70 according to one embodiment of the invention. The portable device 70 may be implemented as an embodiment of the data processing system 203 shown in FIG. 1 and may be a cellular telephone which includes a hinge 87 that couples a display housing 89 to a keypad housing 91. The hinge 87 allows a user to open and close the cellular telephone so that it can be placed in at least one of two different configurations shown in FIGS. 4C and 4D. In one particular embodiment, the hinge 87 may rotatably couple the display housing to the keypad housing. In particular, a user can open the cellular telephone to place it in the open configuration shown in FIG. 4C and can close the cellular telephone to place it in the closed configuration shown in FIG. 4D. The keypad housing 91 may include a keypad 95 which receives inputs (e.g. telephone number inputs or other alphanumeric inputs) from a user and a microphone 97 which receives voice input from the user. The display housing 89 may include, on its interior surface, a display 93 (e.g. an LCD) and a speaker 98 and a proximity sensor 84; on its exterior surface, the display housing 89 may include a speaker 96, a temperature sensor 94, a display 88 (e.g. another LCD), an ambient light sensor 92, and a proximity sensor 84A.

In at least certain embodiments, the portable device 70 may contain components which provide one or more of the functions of a wireless communication device such as a cellular telephone, a media player, an entertainment system, a PDA, or other types of devices described herein. In one implementation of an embodiment, the portable device 70 may be a cellular telephone integrated with a media player which plays MP3 files, such as MP3 music files.

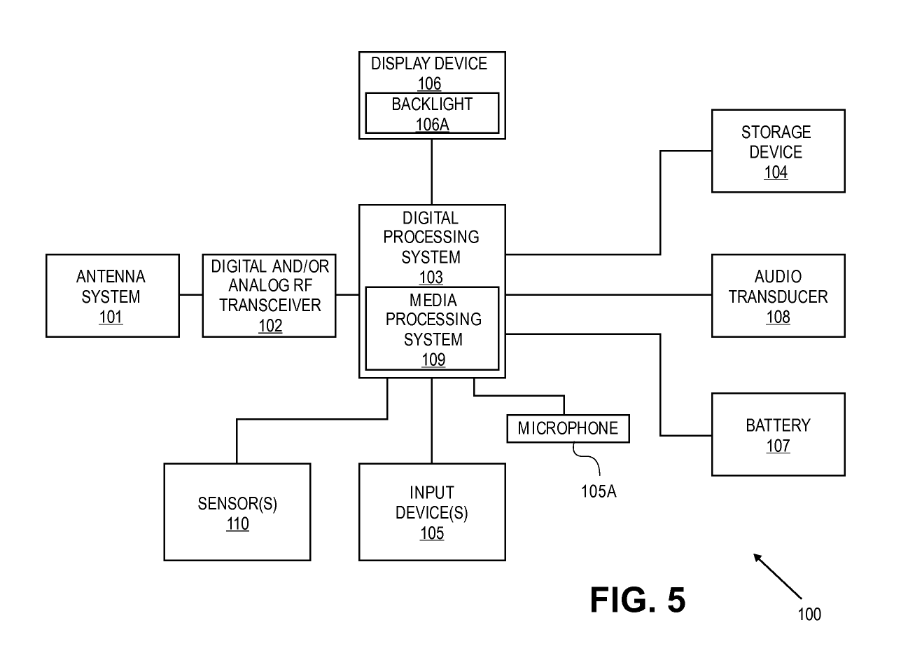

Each of the devices shown in FIGS. 4A, 4B, 4C and 4D may be a wireless communication device, such as a wireless cellular telephone, and may include a plurality of components which provide a capability for wireless communication. FIG. 5 shows an embodiment of a wireless device 100 which includes the capability for wireless communication. The wireless device 100 may be included in any one of the devices shown in FIGS. 4A, 4B, 4C and 4D, although alternative embodiments of those devices of FIGS. 4A, 4B, 4C and 4D may include more or fewer components than the wireless device 100. Furthermore, all or portions of wireless device 100 may be implemented as part of data processing system 203, and wireless device 100 may operate with a device in a manner which is described in the present disclosures.

Wireless device 100 may include an antenna system 101. Wireless device 100 may also include digital and/or analog radio frequency (RF) transceivers 102 (e.g., mobile telephony, Bluetooth, WiFi), coupled to the antenna system 101, to transmit and/or receive voice, digital data and/or media signals through antenna system 101.

Wireless device 100 may also include a digital processing system 103 to control the digital RF transceiver and to manage the voice, digital data and/or media signals. Digital processing system 103 may be a general purpose processing device, such as a microprocessor or controller for example. Digital processing system 103 may also be a special purpose processing device, such as an ASIC (application specific integrated circuit), FPGA (field-programmable gate array) or DSP (digital signal processor). Digital processing system 103 may also include other devices, as are known in the art, to interface with other components of wireless device 1 00. For example, digital processing system 103 may include analog-to-digital and digital-to-analog converters to interface with other components of wireless device 100. Digital processing system 103 may include a media processing system 109, which may also include a general purpose or special purpose processing device to manage media, such as files of audio data.

Wireless device 100 may also include a storage device 104, coupled to the digital processing system, to store data and/or operating programs for the wireless device 100. Storage device 104 may be, for example, any type of solid-state or magnetic memory device.

Wireless device 100 may also include one or more input devices 105, coupled to the digital processing system 103, to accept user inputs (e.g., telephone numbers, names, addresses, media selections, etc.) Input device 105 may be, for example, one or more of a keypad, a touchpad, a touch screen, a pointing device in combination with a display device or similar input device.

Wireless device 100 may also include at least one display device 106, coupled to the digital processing system 103, to display information such as messages, telephone call information, contact information, pictures, movies and/or titles or other indicators of media being selected via the input device 105. Display device 106 may be, for example, an LCD display device. The display device 106 may include a backlight 106a to illuminate the display device 106 under certain circumstances. It will be appreciated that the wireless device 100 may include multiple displays.

Wireless device 100 may also include a battery 107 to supply operating power to components of the system including digital RF transceiver 102, digital processing system 103, storage device 104, input device 105, microphone 105A, audio transducer 108, media processing system 109, sensor(s) 110, and display device 106. Battery 107 may be, for example, a rechargeable or non-rechargeable lithium or nickel metal hydride battery.

Wireless device 100 may also include audio transducers 108, which may include one or more speakers, and at least one microphone 105A. Wireless device 100 may also include one or more sensors 110 coupled to the digital processing system 103.

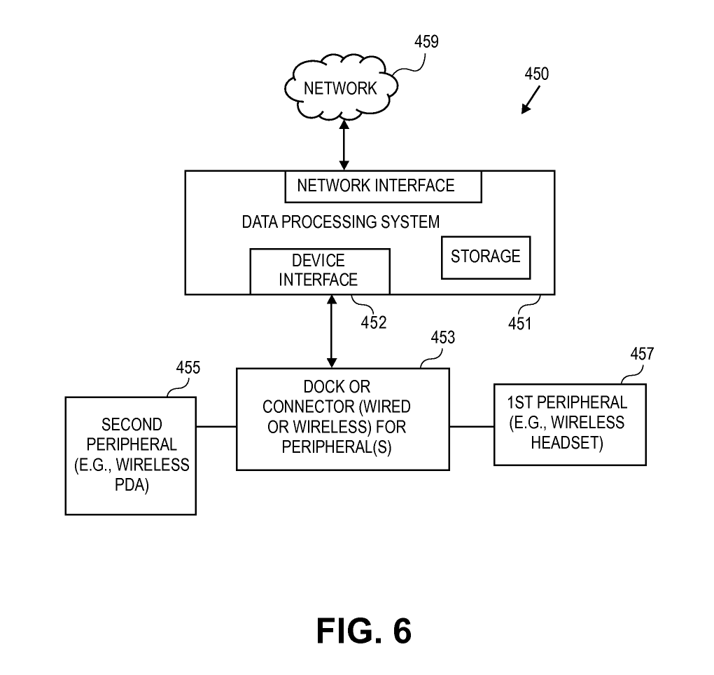

FIG. 6 relates to another aspect of the disclosures described herein. In this aspect, the data processing system 203 may be considered itself a device relative to another data processing system such as the data processing system 451. The system 450 shown in FIG. 6 includes the data processing system 451 which includes a network interface and a device interface and storage. In at least certain embodiments, the data processing system 451 may be a general purpose computer system having a keyboard, and a cursor control device, and a display as well as a network interface to couple the data processing system to a network 459 which may be the Internet or other networks, such as a local area network or a telephone network or a cable TV system network. The network interface may connect to the network either through a wired connection or through a wireless connection and there may be a plurality of network interfaces for different networks or different methods of connecting to the same network or a plurality of networks.

The data processing system typically includes non-volatile mass storage which may store user programs and an operating system and user data including address or contact information, calendar information, and URLs such as favorites or bookmarks for browsing the Internet. The device interface 452 of the data processing system 451 is used to couple the data processing system 451 to a dock or other connector for devices. The dock or other connector 453 may be connected in a wired or wireless manner to the data processing system 451 through the device interface. The dock or connector 453 is designed to connect to one or more devices, such as a first device 457 which may be a wireless headset and a second device 455 which may be a wireless cellular telephone which includes PDA functionality. In one embodiment, the data processing system 203 may be the second device 455 and the device 201 may be the first device 457. The dock may mechanically hold both devices separately or at the same time and may also electrically connect to both devices to provide power to the devices, recharge the batteries of the devices, and to exchange data between the devices and the data processing system 451. The second device 455 may include storage for user information, such as contacts, calendar, and URLs, which may be synchronized with the user's data of a similar type on the data processing system 451. The user may place one or both devices on the dock or connector 453 to cause certain actions to occur as described herein or may remove one or both devices to also cause certain actions to occur automatically as described herein. The dock and/or devices may include mechanical or electrical sensors to detect the placement of the device on the dock or connector and the removal of the device from the dock or connector.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
establishing a first connection between a first device and a second device with a first networking standard and associated first network;
establishing a second connection between the first device and the second device with a second networking standard and associated second network based on the first connection providing information to at least one of the first and second devices regarding the second network; and
transferring data between the first and second devices using the second networking standard.

2. The method of claim 1, further comprising:
authenticating the first device and the second device over the first connection using the first networking standard.

3. The method of claim 1, further comprising:
authenticating the first device and the second device over the second connection using the second networking standard.

4. The method of claim 1, further comprising:
disconnecting the first connection between the first device and the second device with the first networking standard after establishing a second connection between the first device and the second device.

5. The method of claim 1, wherein the first networking standard is a Bluetooth networking standard and the second networking standard is a WiFi networking standard.

6. The method of claim 1, wherein the first network comprises a first wireless local area network and the second network comprises a second wireless local area network.

7. A data processing system, comprising:
a transceiver to detect a wireless signal received from a device transmitting the wireless signal;
a processor coupled to the transceiver, the processor configured to respond to the detected wireless signal by establishing a first connection between the data processing system and the device using a first networking standard and associated first network, wherein the processor is further configured to establish a second connection between the data processing system and the device with a second networking standard and associated second network based on the first connection.

8. The data processing system of claim 7, wherein the processor is further configured to transfer data between the data processing system and the device using the second networking standard and associated second network.

9. The system of claim 7, wherein the processor is further configured to determine a proximity between the data processing system and the device based on the transceiver detecting the wireless signal.

10. The system of claim 9, wherein the processor is further configured to identify a location of the data processing system based on determining the proximity between the data processing system and the device.

11. The system of claim 9, wherein the processor is further configured to react to the location of the data processing system.

12. A method comprising:
establishing a first connection between a first device and a second device using a first networking standard;
identifying a location of the second device based on establishing the first connection between the first device and the second device; and
reacting to the location of the second device.

13. The method of claim 12, wherein reacting to the location of the second device comprises changing a device configuration of the second device.

14. The method of claim 13, wherein changing the device configuration of the second device comprises establishing a second connection between the first device and the second device with a second networking standard having a scaled power setting based on identifying the location of the second device.

15. The method of claim 12, wherein reacting to the location of the second device comprises automatically transferring data between the first device and the second device using the second connection.

16. The method of claim 13, wherein changing the device configuration of the second device comprises at least one of the following:
changing email server settings of the second device;
changing a ringer state of the second device;
changing a background setting of the second device;
prohibiting voice calls to or from the second device;
switching from a cellular network for voice calls to a voice over IP network; and
changing a chat status.

17. A machine readable medium storing executable program instructions which when executed cause a data processing system to perform a method comprising:
establishing a first connection between a first device and a second device using a first networking standard;
identifying a location of the second device based on establishing the first connection between the first device and the second device; and
reacting to the location of the second device.

18. The medium of claim 17, wherein reacting to the location of the second device comprises changing a device configuration of the second device.

19. The medium of claim 18, wherein changing the device configuration of the second device comprises establishing a second connection between the first device and the second device with a second networking standard having a scaled power setting based on identifying the location of the second device.

20. The medium of claim 17, wherein reacting to the location of the second device comprises automatically transferring data between the first device and the second device using the second connection.

21. The medium of claim 18, wherein changing the device configuration of the second device comprises at least one of the following:
changing email server settings of the first device;
changing a ringer state of the first device;
changing a background setting of the first device;
prohibiting voice calls to or from the first device;
switching from a cellular network for voice calls to a voice over IP network; and
changing a chat status.

22. A machine readable medium storing executable program instructions which when executed cause a data processing system to perform a method comprising:
establishing a first connection between a first device and a second device with a first networking standard and associated first network;
establishing a second connection between the first device and the second device with a second networking standard and associated second network based on the first connection providing information to at least one of the first and second devices regarding the second network; and
transferring data between the first and second devices using the second networking standard.

23. The medium of claim 22, further comprising:
authenticating the first device and the second device over the first connection using the first networking standard.

24. The medium of claim 23, further comprising:
authenticating the first device and the second device over the second connection using the second networking standard.

25. The medium of claim 22, further comprising:
disconnecting the first connection between the first device and the second device with the first networking standard after establishing a second connection between the first device and the second device.
